(19) United States
(12) Patent Application Publication
(10) Pub. No.: US 2026/0091598 A1
(43) Pub. Date: Apr. 2, 2026

(54) SHEET CONVEYANCE APPARATUS AND IMAGE FORMING APPARATUS

(71) Applicant: CANON KABUSHIKI KAISHA, Tokyo (JP)

(72) Inventor: KEITARO TAOKA, Chiba (JP)

(21) Appl. No.: 19/330,377

(22) Filed: Sep. 16, 2025

(30) Foreign Application Priority Data
Oct. 1, 2024 (JP) 2024-172774

(51) Int. Cl. B41J 13/00; B41J 11/00; B41J 13/03

(52) U.S. Cl. CPC B41J 13/009; B41J 11/0095; B41J 13/0045; B41J 13/03

(57) ABSTRACT

A sheet conveyance apparatus includes a first conveyance path, a reversing conveyance path, a second conveyance path, a reversing switching unit configured to be switched to a first position where the reversing switching unit guides a leading edge of the sheet from the first conveyance path to the reversing conveyance path, and a second position where the reversing switching unit guides the leading edge from the reversing conveyance path to the second conveyance path, and a driving unit configured to switch the reversing switching unit. The driving unit switches the position of the reversing switching unit from the second position to the first position after a leading edge of the sheet conveyed from the reversing conveyance path passes a tip of the reversing switching unit and before a trailing edge of the sheet passes the tip of the reversing switching unit.

### BACKGROUND

### Field of the Technology

The present disclosure relates to a technique relating to a sheet conveyance apparatus conveying a sheet and an image forming apparatus forming an image on the sheet.

### Description of the Related Art

An image forming apparatus that handles a cut sheet generally includes a reversing mechanism. The reversing mechanism performs switchback operation for switching a sheet conveyance direction by using reversing rollers and a flapper as a reversing switching member, and reverses front and rear print surfaces of the sheet. A flapper of a reversing mechanism, as discussed in Japanese Patent Laid-Open No. 2021-20779, is urged in one direction by an own weight of the flapper itself and an urging spring, and pivots by thrust of the sheet.

However, it is difficult for the sheet having low stiffness to push away the passive flapper as discussed in Japanese Patent Laid-Open No. 2021-20779. Further, since the sheet is conveyed against urging force of the flapper, the flapper may damage a surface of the sheet. Accordingly, in place of the passive flapper, a drive-type flapper, a posture of which is switched by an actuator, can be used.

### SUMMARY

The present disclosure is directed to a sheet conveyance apparatus and an image forming apparatus that can achieve high productivity in a reversing unit that reverses a sheet conveyance direction.

An aspect of the present disclosure provides a sheet conveyance apparatus that includes a first conveyance path through which a sheet is conveyed; reversing rollers configured to convey a sheet in at least one of a forward direction and a direction opposite to the forward direction; a reversing conveyance path through which the sheet conveyed from the first conveyance path is conveyed, with the reversing rollers being provided along the reversing conveyance path; a second conveyance path through which the sheet conveyed from the reversing conveyance path is conveyed; a reversing switching unit configured to be switched to a first position to guide a leading edge of the sheet from the first conveyance path to the reversing conveyance path, and a second position to guide the leading edge of the sheet from the reversing conveyance path to the second conveyance path, and a driving unit configured to switch the reversing switching unit between the first position and the second position. The driving unit switches from the first position to the second position after a trailing edge of a first sheet conveyed from the first conveyance path to the reversing conveyance path passes the reversing switching unit. The driving unit switches from the second position to the first position after a leading edge of the first sheet conveyed from the reversing conveyance path passes a tip of the reversing switching unit and before the trailing edge of the first sheet passes the tip of the reversing switching unit.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming system.

FIG. 2 is a cross-sectional view of a second reversing unit.

FIG. 3A illustrates a reversing flapper driving unit and a reversing flapper according to a first embodiment.

FIG. 3B illustrates the reversing flapper positioned at a first position according to the first embodiment.

FIG. 3C illustrates the reversing flapper positioned at a second position according to the first embodiment.

FIG. 4 illustrates sheet conveyance and reversing flapper operation according to the first embodiment.

FIG. 5 illustrates the sheet conveyance and the reversing flapper operation according to the first embodiment.

FIG. 6 illustrates the sheet conveyance and the reversing flapper operation according to the first embodiment.

FIG. 7 illustrates the sheet conveyance and the reversing flapper operation according to the first embodiment.

FIG. 8 illustrates the sheet conveyance and the reversing flapper operation according to the first embodiment.

FIG. 9 illustrates the sheet conveyance and the reversing flapper operation according to the first embodiment.

FIG. 10 illustrates the sheet conveyance and the reversing flapper operation according to the first embodiment.

FIG. 11A illustrates a reversing flapper positioned at a first position according to a second embodiment.

FIG. 11B illustrates the reversing flapper positioned at a second position according to the second embodiment.

FIG. 12 is a cross-sectional view of a second reversing unit according to the second embodiment.

FIG. 13 is a block diagram of the second reversing unit.

FIG. 14 is a cross-sectional view of a reversing module.

FIG. 15 is a cross-sectional view of a fixing module.

FIG. 16A is a cross-sectional view of a pre-reversing switching unit and components surrounding the pre-reversing switching unit.

FIG. 16B is a cross-sectional view of the pre-reversing switching unit and components surrounding the pre-reversing switching unit.

FIG. 17A is a cross-sectional view of the reversing flapper positioned at the first position and components surrounding the reversing flapper.

FIG. 17B is a cross-sectional view of the reversing flapper positioned at the second position and components surrounding the reversing flapper.

### DESCRIPTION OF THE EMBODIMENTS

Some embodiments are described with reference to drawings. The embodiments described below are preferred embodiments of the present disclosure, and accordingly, various technically preferable limitations are given thereto; however, the scope of the present disclosure is not unreasonably limited by the following description. All components described in the embodiments are not essential components of the present disclosure.

### First Embodiment

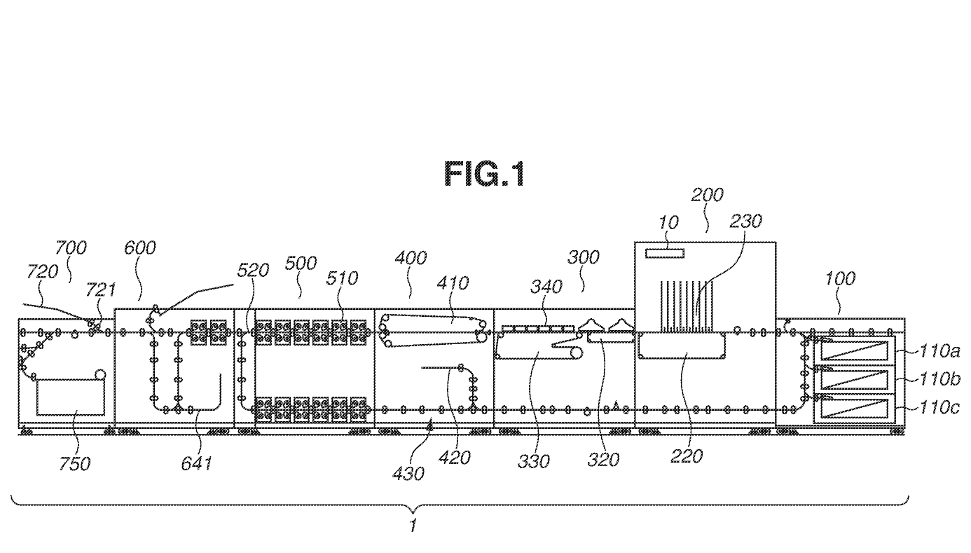

In a first embodiment, a case where an image forming system is applied to an inkjet recording system 1 is described. FIG. 1 is a schematic diagram illustrating an example of an outline configuration of the inkjet recording system 1. The inkjet recording system 1 is of a sheet-feeding type in which a printed material is manufactured by forming an ink image on a sheet by using two liquids of reaction liquid and ink.

The inkjet recording system 1 according to the present embodiment includes an image forming apparatus and a plurality of sheet conveyance apparatuses in combination. In the present embodiment, an apparatus that can independently stand by underbody parts such as casters and adjusters, and may provide an independent housing.

The inkjet recording system 1 includes a sheet feeding module 100, a print module 200, a drying module 300, a fixing module 400, a cooling module 500, a reversing module 600, and a sheet discharging stacking module 700. A sheet in a cut paper shape supplied from the sheet feeding module 100 is conveyed along a conveyance path, is processed by each module, and is discharged to the sheet discharging stacking module 700 serving as a sheet discharging apparatus.

The sheet feeding module 100 that is an example of a sheet feeding apparatus includes storages 110a, 110b, and 110c for storing sheets. The storages 110a, 110b, and 110c are configured to be drawable toward a front side of the apparatus. The sheets are fed one by one by a separation belt and a conveyance roller from each of the storages 110a, 110b, and 110c, and are conveyed to the print module 200. The number of storages 110a, 110b, and 110c is not limited to three, and one, two, or four or more storages may be provided.

The print module 200 that is an example of an image forming apparatus forming an image on a sheet includes a pre-image-formation registration correction unit, a print belt unit 220, and a recording unit 230. A sheet conveyed from the sheet feeding module 100 is corrected in inclination and position by the pre-image-formation registration correction unit, and is then conveyed to the print belt unit 220. The recording unit 230 is disposed at a position facing the print belt unit 220 with a conveyance path in between. The recording unit 230 is a sheet processing unit that performs recording processing (printing) on the conveyed sheet from above by using a plurality of print head, to form an image. The plurality of print heads is arranged along a conveyance direction. In the present embodiment, the recording unit 230 includes five line-type print heads corresponding to four colors of yellow (Y), magenta (M), cyan (C), and black (Bk), and the reaction liquid. The number of colors and the number of print heads are not limited to five.

As an inkjet method, a method using a heater element, a method using a piezoelectric element, a method using an electrostatic element, a method using a microelectromechanical system (MEMS) element, or the like can be adopted. Ink of the colors is supplied to the respective print heads from ink tanks through ink tubes. The sheet printed by the recording unit 230 is sucked and conveyed by the print belt unit 220 while a clearance between the sheet and the print heads is secured. The sheet printed by the recording unit 230 is subjected to deviation detection and color density detection of the image formed on the sheet by an inline scanner disposed on a downstream side of the recording unit 230 in the conveyance direction. A detection result is used for correction of a printed image. In the present embodiment, the recording unit 230 is an example of an image forming unit.

The drying module 300 includes a decoupling unit 320, a drying belt unit 330, and a hot-air blowing unit 340. The drying module 300 reduces a liquid component contained in the link imparted to the sheet by the recording unit 230 of the print module 200, thereby enhancing fixation of the sheet and the ink. The sheet printed by the recording unit 230 of the print module 200 is conveyed to the decoupling unit 320 disposed in the drying module 300. In the decoupling unit 320, the sheet can be conveyed by pressure of the air from above and friction with the belt. The sheet on the belt is conveyed while being weakly held, which prevents deviation of the sheet on the print belt unit 220 forming the ink image. The drying belt unit 330 is disposed below the conveyed sheet, the hot-air blowing unit 340 is disposed above the conveyed sheet, and the drying belt unit 330 and the hot-air blowing unit 340 are disposed to face each other with the belt in between.

The sheet conveyed from the decoupling unit 320 is sucked and conveyed by the drying belt unit 330. At the same time, the sheet receives hot air from the hot-air blowing unit 340, and an ink imparted surface is dried. As a drying method, in addition to the method of applying the hot air, a method of irradiating the sheet surface with electromagnetic waves (such as ultraviolet rays and infrared rays), and a method of conducting heat through contact of a heating element may be combined.

The fixing module 400 includes a fixing belt unit 410. The fixing belt unit 410 includes an upper belt unit and a lower belt unit, and causes the sheet conveyed from the drying module 300 to pass through between the heated upper belt unit and the lower belt unit, thereby fixing the ink to the sheet.

The cooling module 500 includes a plurality of cooling units 510, and cools the high-temperature sheet conveyed from the fixing module 400. Each of the cooling units 510 is configured to intake external air into a cooling box by a fan, to increase pressure inside the cooling box, and to apply air blown out from a nozzle formed in a conveyance guide to the sheet to cool the sheet. The cooling units 510 are disposed on both upper and lower sides of the conveyance path, and cool the sheet from both surfaces.

In addition, the cooling module 500 includes a conveyance path switching unit 520, and can switch the sheet conveyance path depending on a case where the sheet is conveyed to the reversing module 600 and a case where the sheet is conveyed to a duplex conveyance path used for duplex printing. In the duplex printing, the sheet is conveyed to a conveyance path at a lower part of the cooling module 500. In this case, the sheet is further conveyed from the cooling module 500 along the duplex conveyance path of the fixing module 400, the drying module 300, the print module 200, and the sheet feeding module 100. A first reversing unit 420 that reverses front and rear surfaces of the sheet is provided in a duplex conveyance unit 430 of the fixing module 400. The sheet is again conveyed to the pre-image-formation registration correction unit, the print belt unit 220, and the recording unit 230 of the print module 200, and is printed by the recording unit 230.

The reversing module 600, which includes a second reversing unit 641, can reverse front and rear surfaces of the conveyed sheet, and can freely change between forward and reverse directions of the discharged sheet.

The sheet discharging stacking module 700 includes a top tray 720 and a stacking unit 750, and aligns and stacks the sheet conveyed from the reversing module 600. The sheet discharging stacking module 700 further includes a top tray switching unit 721. The top tray switching unit 721 switches a discharge destination of the sheet between the top tray 720 and the stacking unit 750.

A control unit 10 includes a central processing unit (CPU), a random access memory (RAM), and a read only memory (ROM), and controls each of the units of the inkjet recording system 1. The CPU outputs signals for operating electric parts at desired timings with associated control amounts, to the electric parts based on detection signals input from sensors and information stored in the ROM. The ROM and the RAM store information data for controlling the units. The CPU reads the information data stored in the ROM or writes information data to the RAM. In the present embodiment, the control unit 10 may control an external computer connected to the inkjet recording system 1.

### Reversing Module

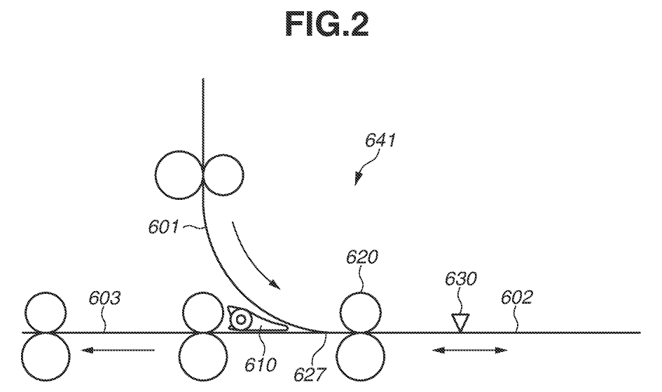

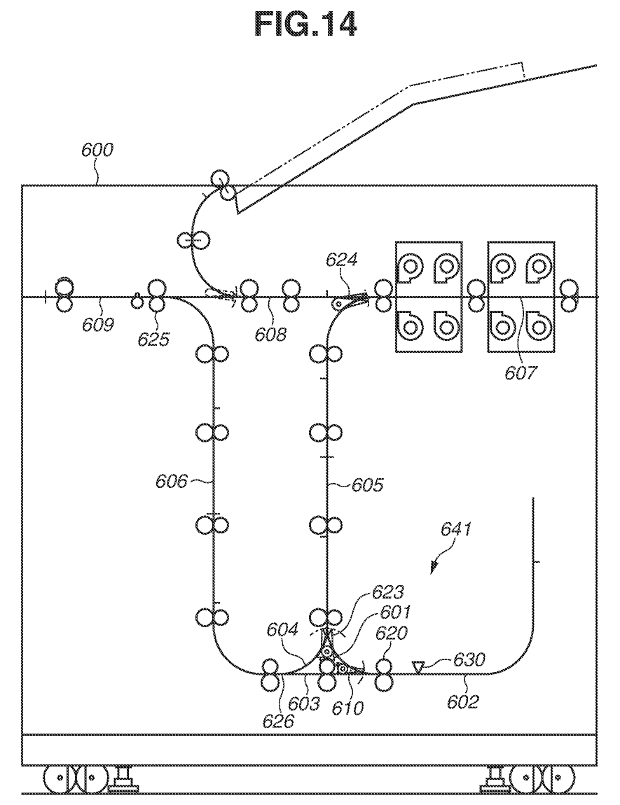

A configuration of the reversing module 600 is described with reference to FIG. 2 and FIG. 14. FIG. 14 is a cross-sectional view illustrating a sheet conveyance path in the reversing module 600. FIG. 2 is a cross-sectional view illustrating the second reversing unit 641 of the reversing module 600. The reversing module 600 includes an inlet conveyance path 607, a horizontal conveyance path 608, an outlet conveyance path 609, a downward conveyance path 605, a pre-reversing conveyance path 601, a reversing conveyance path 602, a post-reversing conveyance path 603, a returning conveyance path 604, and an upward conveyance path 606. The reversing module 600 further includes an inlet switching unit 624, a pre-reversing switching unit 623, a reversing flapper 610 as a reversing switching unit, reversing rollers 620, a reversing sensor 630, a plurality of conveyance rollers, and a plurality of sensors.

The reversing module 600 includes the inlet conveyance path 607 that substantially horizontally receives the sheet from an upstream apparatus (in present embodiment, cooling module 500) for conveying the sheet, and the inlet switching unit 624 that branches and switches the conveyance path from the inlet conveyance path 607. One of the paths branched by the inlet switching unit 624 is the horizontal conveyance path 608 for substantially horizontally conveying the sheet to a merging unit 625. The outlet conveyance path 609 is provided on a downstream part of the merging unit 625 in a direction of sheet conveyance, for delivering the sheet to a downstream apparatus (in present embodiment, sheet discharging stacking module 700) connected to the reversing module 600. The outlet conveyance path 609 is also a substantially horizontal conveyance path. The horizontal conveyance path 608 couples the inlet switching unit 624 and the merging unit 625.

The other path branched by the inlet switching unit 624 is the downward conveyance path 605 that extends in a substantially vertical (downward) direction from the inlet conveyance path 607 and conveys the sheet downward in a substantially vertical direction. The pre-reversing switching unit 623 that switches the path to any of the pre-reversing conveyance path 601 and the returning conveyance path 604 is provided at a downstream end of the downward conveyance path 605 in the direction of sheet conveyance.

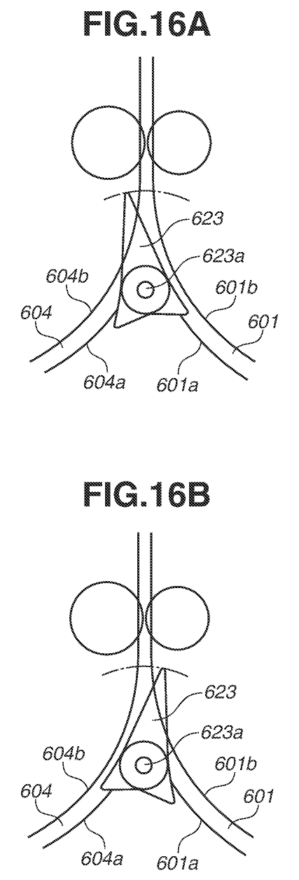

FIGS. 16A and 16B are cross-sectional views of the pre-reversing switching unit 623 and components surrounding the pre-reversing switching unit 623. FIG. 16A illustrates the pre-reversing switching unit 623 when the pre-reversing switching unit 623 guides the sheet to the pre-reversing conveyance path 601. FIG. 16B illustrates the pre-reversing switching unit 623 when the pre-reversing switching unit 623 guides the sheet to the returning conveyance path 604. The pre-reversing switching unit 623 pivots on a pre-reversing switching shaft 623a.

As viewed from a sheet width direction, the pre-reversing switching unit 623 is switched to a position (FIG. 16B) at which the pre-reversing switching unit 623 overlaps with a conveyance guide 601b forming a portion of the pre-reversing conveyance path 601 and to a position (FIG. 16A) at which the pre-reversing switching unit 623 overlaps with a conveyance guide 604b included in the returning conveyance path 604. The conveyance guide 601b is positioned further away from the pre-reversing switching shaft 623a than conveyance guide 601a forming an opposite portion of the pre-reversing conveyance path 601. The conveyance guide 604b is positioned further away from the pre-reversing switching shaft 623a than conveyance guide 604a forming an opposite portion of the conveyance path 604. In other words, the pre-reversing switching unit 623 is switched to a position at which the pre-reversing switching unit 623 blocks the pre-reversing conveyance path 601 or to a position at which the pre-reversing switching unit 623 blocks the returning conveyance path 604.

As illustrated in FIG. 14, the pre-reversing conveyance path 601 is continuous with the reversing conveyance path 602 for performing switchback to reverse a leading edge and a trailing edge of the sheet in a traveling direction. The reversing flapper 610 that guides the sheet from the pre-reversing conveyance path 601 to the reversing conveyance path 602, and guides the sheet to the post-reversing conveyance path 603 for conveying the sheet switched back by the reversing conveyance path 602 is provided at a downstream end of the pre-reversing conveyance path 601.

A downstream end of the returning conveyance path 604 and a downstream end of the post-reversing conveyance path 603 are merged and continuous with the upward conveyance path 606 returning toward the outlet conveyance path 609. The returning conveyance path 604 couples the pre-reversing switching unit 623 and a merging portion 626. In a case where the sheet is discharged through the downward conveyance path 605, the returning conveyance path 604, and the upward conveyance path 606, the sheet is discharged while a printed surface is directed upward (face-up). In contrast, in a case where the sheet is discharged through the downward conveyance path 605, the pre-reversing conveyance path 601, the reversing conveyance path 602, the post-reversing conveyance path 603, and the upward conveyance path 606, the sheet is discharged while the printed surface is directed downward (face-down).

As described above, the reversing module 600 is a sheet reversing conveyance apparatus including three patterns of sheet conveyance paths. The three patterns of sheet conveyance paths are a sheet conveyance path for diverting and conveying the received sheet, a reversing conveyance path for diverting, reversing, and conveying the received sheet, and a sheet conveyance path for substantially linearly conveying the received sheet without bending the received sheet.

The first sheet conveyance path is a path for conveying the sheet from the inlet conveyance path 607 to the outlet conveyance path 609 through the downward conveyance path 605, the returning conveyance path 604, and the upward conveyance path 606. The second sheet conveyance path is a path for conveying the sheet from the inlet conveyance path 607 to the outlet conveyance path 609 through the downward conveyance path 605, the pre-reversing conveyance path 601, the reversing conveyance path 602, the post-reversing conveyance path 603, and the upward conveyance path 606. The third sheet conveyance path is a path for conveying the sheet from the inlet conveyance path 607 to the outlet conveyance path 609 through the horizontal conveyance path 608.

The conveyance path suitable for the sheet type and the job type can be selected from the three patterns of sheet conveyance paths. In a case of using a sheet having relatively low stiffness, even when the sheet is caused to pass through a bypass conveyance path passing through the downward conveyance path 605 and the upward conveyance path 606, there is a low risk of image damage due to bending of the sheet during passage. Accordingly, quality of a product can be secured. However, in a case of using a sheet having relatively high stiffness, when the sheet is caused to pass through the bypass conveyance path passing through the downward conveyance path 605 and the upward conveyance path 606, there is a greater risk of image damage due to bending of the sheet during passage. Accordingly, quality of the product may be deteriorated. In other words, when the sheet having relatively high stiffness is bent, contacting force between the sheet and the sheet conveyance path is increased due to stiffness that is force for returning the sheet to a flat surface shape before bending. Since the sheet is conveyed in a state where the sheet is in contact with the sheet conveyance path with high contacting force, damage may occur on a surface of the sheet in contact with the sheet conveyance path, or the image may be peeled. For this reason, the conveyance path through which the sheet is conveyed without being bent as much as possible is used for the sheet having high stiffness.

For example, in a case where an inspection module serving as a reading apparatus is installed between the cooling module 500 and the reversing module 600, the sheet is conveyed to a route passing through the downward conveyance path 605 and the upward conveyance path 606, to be subjected to a purge inspection. In a case where an image read by the inspection module is a normal image, the sheet is discharged to the stacking unit 750, whereas in a case where the read image is an abnormal image, the sheet is discharged to the top tray 720. Accordingly, the control unit 10 can acquire a result of the purge inspection before the leading edge of the sheet reaches the top tray switching unit 721.

For example, when printing is performed while a job for conveying a sheet in a face-up manner to the downstream and a job for conveying a sheet in a face-down manner to the downstream are randomly mixed, a mode in which the sheet is caused to pass through a route passing through the downward conveyance path 605 and the upward conveyance path 606 is selectable. In a case of the job of face-down conveyance, the sheet is caused to pass through the downward conveyance path 605 and the upward conveyance path 606. In a case of the job of face-up conveyance, it is possible to cause the sheet to pass through the horizontal conveyance path 608, but in a case where the job of face-up conveyance is performed after the job of face-down conveyance, a sheet interval between the jobs is expanded. For this reason, in the present embodiment, deterioration in total productivity can be suppressed in a case where the sheet in the job of face-up conveyance and the sheet in the job of face-down conveyance are both caused to pass through the downward conveyance path 605 and the upward conveyance path 606.

### Second Reversing Unit

As illustrated in FIG. 2, the second reversing unit 641 includes the pre-reversing conveyance path 601, the reversing conveyance path 602, the post-reversing conveyance path 603, the reversing rollers 620, the reversing sensor 630, and the reversing flapper 610. The second reversing unit 641 includes the pre-reversing conveyance path 601 through which the sheet on which switchback has not been performed yet passes, the reversing conveyance path 602 for performing switchback to reverse the leading edge and the trailing edge of the sheet in the traveling direction, and the post-reversing conveyance path 603 through which the sheet on which switchback has been already performed passes. In FIG. 2, a merging point 627 is a point at which the pre-reversing conveyance path 601, the reversing conveyance path 602, and the post-reversing conveyance path 603 are merged.

In the second reversing unit 641, the reversing flapper 610 that is a part of the pre-reversing conveyance path 601 and a part of the post-reversing conveyance path 603 is disposed at an end point of the pre-reversing conveyance path 601 and at a start point of the post-reversing conveyance path 603 in direction of sheet conveyance. The reversing rollers 620 are disposed along the reversing conveyance path 602. For the switchback operation, the reversing rollers 620 receive and convey a sheet on which switchback has not been performed yet, stop the sheet at a predetermined position, and then convey the sheet in an opposite direction. The reversing sensor 630 is disposed along the reversing conveyance path 602, and detects a position of the sheet in order to control a timing when the sheet is stopped in the switchback operation by the reversing rollers 620. Arrows in FIG. 2 indicate sheet conveyance directions.

The pre-reversing conveyance path 601 is a conveyance path that includes at least one bend, and the post-reversing conveyance path 603 is a substantially horizontal conveyance path. In the present embodiment, in a vicinity of the merging point 627 around the merging point 627, a smaller angle among angles formed by the reversing conveyance path 602 and the post-reversing conveyance path 603 is greater than a smaller angle among angles formed by the reversing conveyance path 602 and the pre-reversing conveyance path 601. In FIG. 2, the smaller angle of the angles formed by the reversing conveyance path 602 and the post-reversing conveyance path 603 is 180 degrees. In the present embodiment, the pre-reversing conveyance path 601 is an example of a first conveyance path, and the post-reversing conveyance path 603 is an example of a second conveyance path. The post-reversing conveyance path 603 may also be bent. Bending of the post-reversing conveyance path 603 can be smaller than bending of the pre-reversing conveyance path 601. In other words, a curvature of the post-reversing conveyance path 603 can be smaller than a curvature of the pre-reversing conveyance path 601.

The pre-reversing conveyance path 601 may be integrated with the downward conveyance path 605. In other words, in the pre-reversing conveyance path 601, an upstream side in a direction of sheet conveyance may extend in a substantially vertically direction, and a downstream side in a direction of sheet conveyance where the reversing flapper 610 is disposed may be bent.

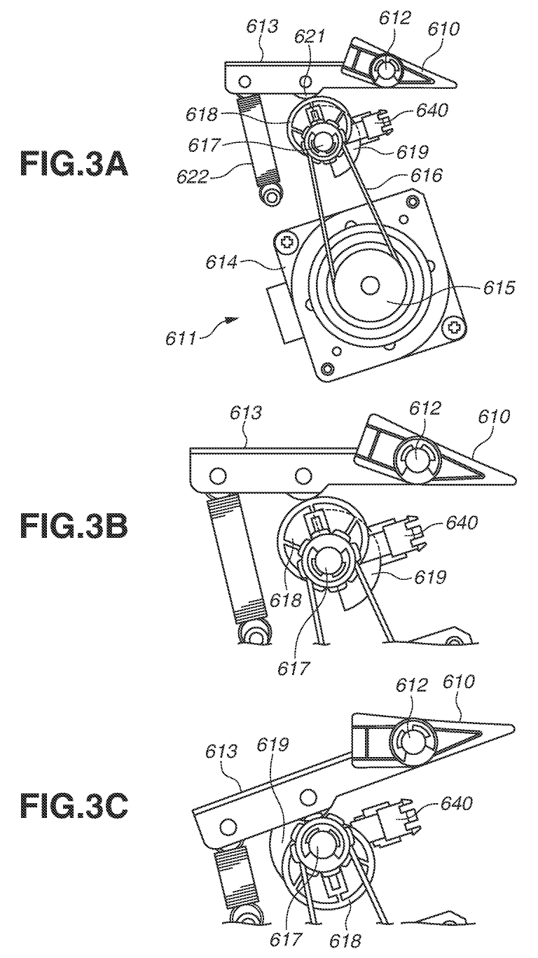

A mechanism for operating the reversing flapper 610 is described. FIG. 3A is a diagram illustrating the reversing flapper 610 and a reversing flapper driving unit 611. FIG. 3B is a diagram illustrating the reversing flapper 610 in a pre-reversing guiding posture (first position) for guiding the sheet from the pre-reversing conveyance path 601 to the reversing conveyance path 602. FIG. 3C is a diagram illustrating the reversing flapper 610 in a post-reversing guiding posture (second position) for guiding the sheet from the reversing conveyance path 602 to the post-reversing conveyance path 603.

The reversing flapper 610 includes a reversing flapper shaft 612, and pivots around the reversing flapper shaft 612. The reversing flapper 610 is fixed to the reversing flapper shaft 612. The reversing flapper shaft 612 is pivotably supported by a side plate. Further, a reversing flapper arm 613 integrated with the reversing flapper shaft 612 is disposed at an end part on a side of the reversing flapper shaft 612 where the reversing flapper driving unit 611 is disposed along the sheet width direction. In other words, the reversing flapper arm 613 is disposed on an outside of the reversing flapper shaft 612 in the sheet width direction.

The reversing flapper driving unit 611 is fixed to a side plate. The reversing flapper driving unit 611 includes a motor 614 serving as a driving unit, a motor base holding the motor 614, and a timing belt 616 transmitting rotation of a motor pulley 615 attached on a motor shaft. The reversing flapper driving unit 611 further includes a cam shaft 617 that is rotatably supported by the motor base and is rotated by the timing belt 616, a cam 618 fixed to the cam shaft 617, and a flag 619 fixed to the cam shaft 617. The reversing flapper driving unit 611 further includes a reversing flapper home position (HP) sensor 640 that is fixed to the motor base and detects a phase of the cam shaft 617.

In the present embodiment, a photo-interrupter is used as the reversing flapper HP sensor 640.

In a process in which the flag 619 is rotated, a position of the flag 619 rotated by a preset rotation amount from a timing when the flag 619 shields an optical axis of the photo-interrupter or a timing when the flag 619 is removed from the optical axis and light is transmitted is set as an optional posture of the reversing flapper 610. The reversing flapper arm 613 is urged by a reversing flapper spring 622 such that a cam contacting portion 621 of the reversing flapper arm 613 is in contact with the cam 618. With such a configuration, when the cam 618 is rotated with rotation of the motor 614, the reversing flapper arm 613 pivots around the reversing flapper shaft 612, and the posture of the reversing flapper 610 is switched.

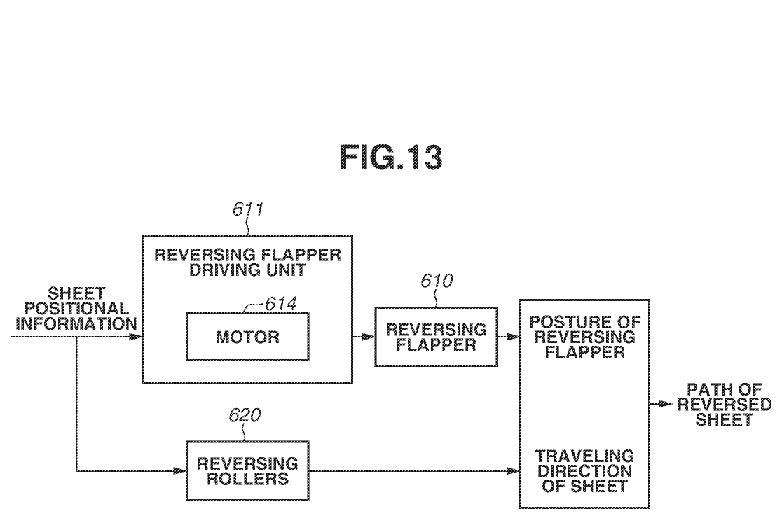

FIG. 13 is a block diagram illustrating a configuration of the second reversing unit 641. Driving of the motor 614 of the reversing flapper driving unit 611 is controlled based on sheet positional information detected by the sensor disposed along the conveyance path. The reversing flapper driving unit 611 switches the posture of the reversing flapper 610. Further, normal rotation, stop, and reverse rotation of the reversing rollers 620 are controlled based on the sheet positional information. When a rotation direction of the reversing rollers 620 is switched, the traveling direction of the sheet nipped by the reversing rollers 620 is switched.

### Operation of Reversing Flapper

Operation of the reversing flapper in a case where sheets are continuously fed is described. To realize high productivity, sheets are conveyed within a narrowed sheet interval. At the reversing unit that reverses the direction of sheet conveyance, the sheet interval indicates an interval between a preceding sheet on which switchback has been already performed and a subsequent sheet on which switchback has not been performed yet. In a case where the sheet interval is narrowed, when the posture of the reversing flapper 610 is switched, the reversing flapper 610 may come into contact with the trailing edge of the sheet and damage the sheet. In the present embodiment, a position of the reversing flapper 610 is switched to the first position where the reversing flapper 610 does not block the pre-reversing conveyance path 601 and the post-reversing conveyance path 603 and the second position where the reversing flapper 610 blocks the pre-reversing conveyance path 601 but does not block the post-reversing conveyance path 603. This makes it possible to suppress damage to the sheet by the reversing flapper 610.

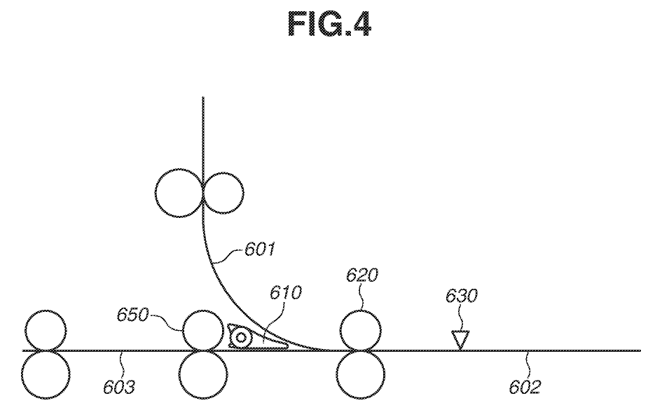

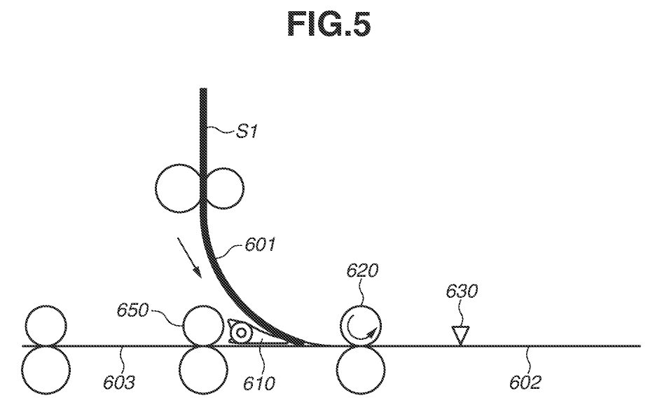

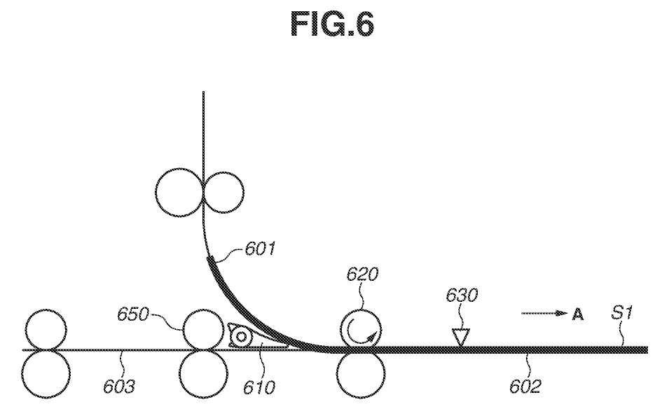

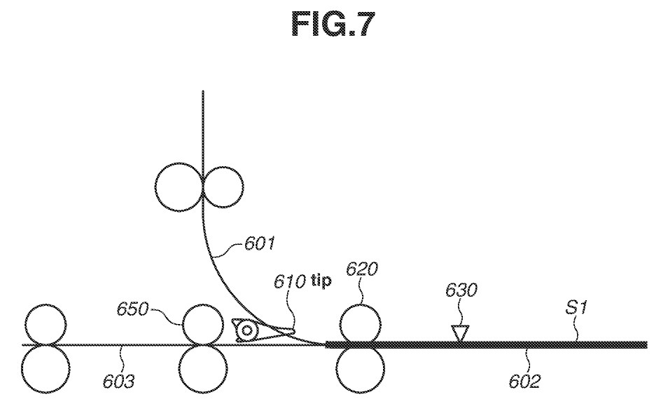

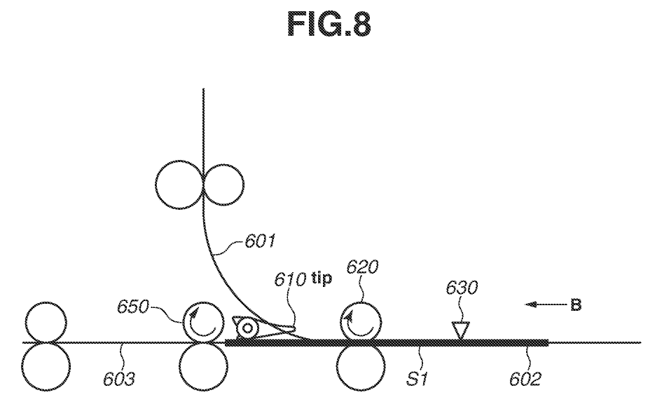

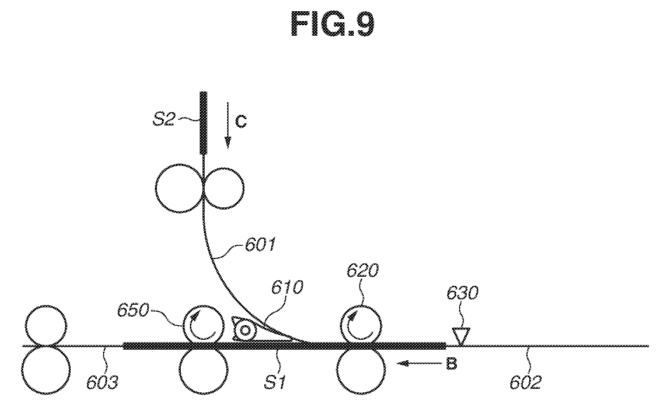

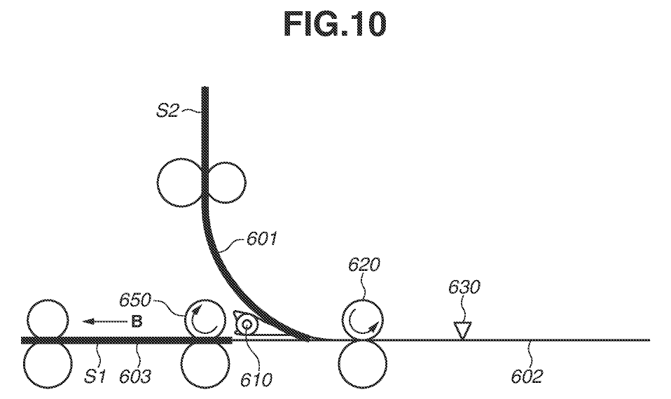

A flow of the sheet and the operation of the reversing flapper 610 in the present embodiment are described with reference to FIG. 4 to FIG. 10. FIG. 4 illustrates the reversing flapper 610 positioned at the first position before the sheet is conveyed. FIG. 5 and FIG. 6 illustrate the reversing flapper 610 positioned at the first position when the sheet on which switchback has not been performed yet is conveyed from the pre-reversing conveyance path 601 to the reversing conveyance path 602. FIG. 7 and FIG. 8 illustrate the reversing flapper 610 positioned at the second position when the sheet is conveyed from the reversing conveyance path 602 to the post-reversing conveyance path 603. FIG. 9 and FIG. 10 illustrate the reversing flapper 610 positioned at the first position when the sheet is conveyed from the reversing conveyance path 602 to the post-reversing conveyance path 603.

As illustrated in FIG. 4, before the sheet is conveyed, the reversing flapper 610 is positioned at the first position that is the pre-reversing guiding posture (FIG. 3B) in which the reversing flapper 610 can receive the sheet on which switchback has not been performed yet and convey the sheet. When the reversing flapper 610 is at the first position, the reversing flapper 610 is in a posture in which the reversing flapper 610 does not block the pre-reversing conveyance path 601 or the post-reversing conveyance path 603.

In a state where the reversing flapper 610 is positioned at the first position, the leading edge of the sheet on which switchback has not been performed yet passes the reversing flapper 610 (FIG. 5). The reversing rollers 620 that are normally rotating receive the sheet, and continue conveyance of the sheet in a direction A (FIG. 6). As illustrated in FIG. 7, when the sheet is conveyed by a predetermined distance after the reversing sensor 630 detects passage of the leading edge of the sheet, rotation of the reversing rollers 620 is stopped and conveyance of the sheet is stopped. The predetermined distance depends on a length of the sheet in the conveyance direction. At this time, immediately after the trailing edge of the sheet passes a tip 610tip of the reversing flapper 610, the motor 614 switches the position of the reversing flapper 610 to the second position that is the post-reversing guiding posture (FIG. 3C) in which the reversing flapper 610 guides the sheet on which switchback has been already performed to the post-reversing conveyance path 603.

The second position of the reversing flapper 610 is a posture in which the reversing flapper 610 blocks the pre-reversing conveyance path 601.

As illustrated in FIG. 8, in a state where the reversing flapper 610 is positioned at the second position, the reversing rollers 620 are reversely rotated to convey the sheet in a direction B. Post-reversing conveyance rollers 650 are disposed on an upstream side of the post-reversing conveyance path 603, and further convey the sheet on which switchback has been already performed downstream. As illustrated in FIG. 9, in a state where the sheet is conveyed by the post-reversing conveyance rollers 650 in the direction B, the motor 614 switches the posture of the reversing flapper 610 from the post-reversing guiding posture (second position) to the pre-reversing guiding posture (first position).

In this state, although the trailing edge of the sheet passing through the post-reversing conveyance path 603 has not passed through the reversing flapper 610, the reversing flapper 610 is at the position at which the reversing flapper 610 does not block the post-reversing conveyance path 603, and accordingly, the posture of the reversing flapper 610 can be switched even though the sheet is passing through the reversing flapper 610. In other words, at a timing after the leading edge of the sheet passes the tip 610tip of the reversing flapper 610 and before the trailing edge of the sheet reaches the tip 610tip of the reversing flapper 610, the posture of the reversing flapper 610 can start to be switched from the post-reversing guiding posture to the pre-reversing guiding posture. By operating the reversing flapper 610 in the above-described manner, the posture of the reversing flapper 610 is switched to the pre-reversing guiding posture (first posture) at a timing before a leading edge of a subsequent sheet S2 following a preceding sheet S1 in a direction C (FIG. 9) reaches the pre-reversing conveyance path of the reversing flapper 610 (FIG. 10). In the present embodiment, the reversing flapper 610 is an example of a reversing switching unit.

In the present embodiment, the position of the reversing flapper 610 is switched from the second position to the first position after the leading edge of the sheet is nipped by the post-reversing conveyance rollers 650, but the timing is not limited to the example. As long as the leading edge of the sheet has passed the tip 610tip of the reversing flapper 610 during conveyance of the sheet from the reversing conveyance path 602 to the post-reversing conveyance path 603, the position of the reversing flapper 610 may be switched from the second position to the first position.

In the present embodiment, the post-reversing conveyance path 603 is formed on a straight line of a nip line of the reversing rollers 620. For this reason, in a process in which the sheet passes through the post-reversing conveyance path 603, the sheet does not actively come into contact with the reversing flapper 610. Even when the posture of the reversing flapper 610 is switched while the sheet passes through the post-reversing conveyance path 603, the sheet contacting state is hardly affected by the change. Accordingly, even when the posture of the reversing flapper 610 is switched while the sheet passes through the post-reversing conveyance path 603, sheet conveyance by the reversing rollers 620 and the post-reversing conveyance rollers 650 can be stably performed.

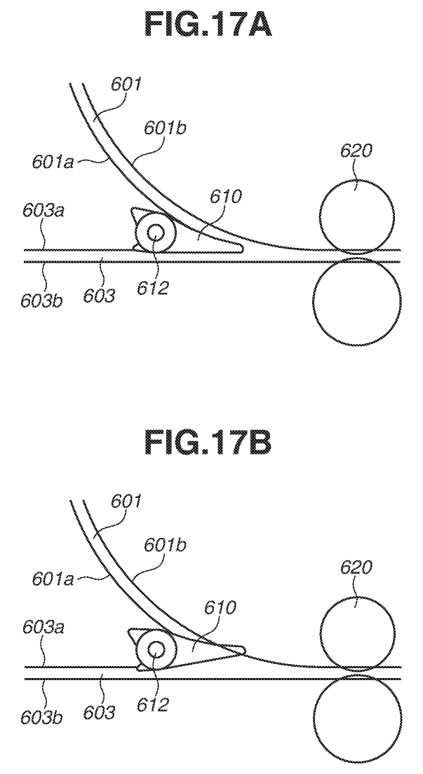

FIGS. 17A and 17B are cross-sectional views of the reversing flapper 610 and components surrounding the reversing flapper 610. FIG. 17A illustrates the reversing flapper 610 positioned at the first position, and FIG. 17B illustrates the reversing flapper 610 positioned at the second position. The conveyance guide 601a and the conveyance guide 601b form the pre-reversing conveyance path 601. Further, a conveyance guide 603a and a conveyance guide 603b form the post-reversing conveyance path 603.

In the present embodiment, in the case where the reversing flapper 610 is at the second position (FIG. 17B), the reversing flapper 610 and the conveyance guide 601b that is disposed at a position facing the reversing flapper 610 and forms the pre-reversing conveyance path 601 overlap with each other as viewed from the sheet width direction. In other words, when the reversing flapper 610 is at the second position, the reversing flapper 610 intersects the conveyance guide 601b disposed at a position farther from the reversing flapper shaft 612, out of the conveyance guides 601a and 601b included in the pre-reversing conveyance path 601. However, in the case where the reversing flapper 610 is at the second position, the reversing flapper 610 may not completely block the pre-reversing conveyance path 601, and it is sufficient for the reversing flapper 610 to block at least a part of the pre-reversing conveyance path 601, as viewed from the sheet width direction. In the present embodiment, it is sufficient that, when the sheet is conveyed from the reversing conveyance path 602 to the post-reversing conveyance path 603, the sheet is conveyed to the post-reversing conveyance path 603 without being conveyed to the pre-reversing conveyance path 601. As illustrated in FIG. 17A, in the case where the reversing flapper 610 is at the first position, the reversing flapper 610 does not overlap with the conveyance guide 601b that is disposed at a position facing the reversing flapper 610 and forms the pre-reversing conveyance path 601. In the case where the reversing flapper 610 is at the first position, the reversing flapper 610 does not overlap with the conveyance guide 603b that is disposed at a position facing the reversing flapper 610 and forms the post-reversing conveyance path 603.

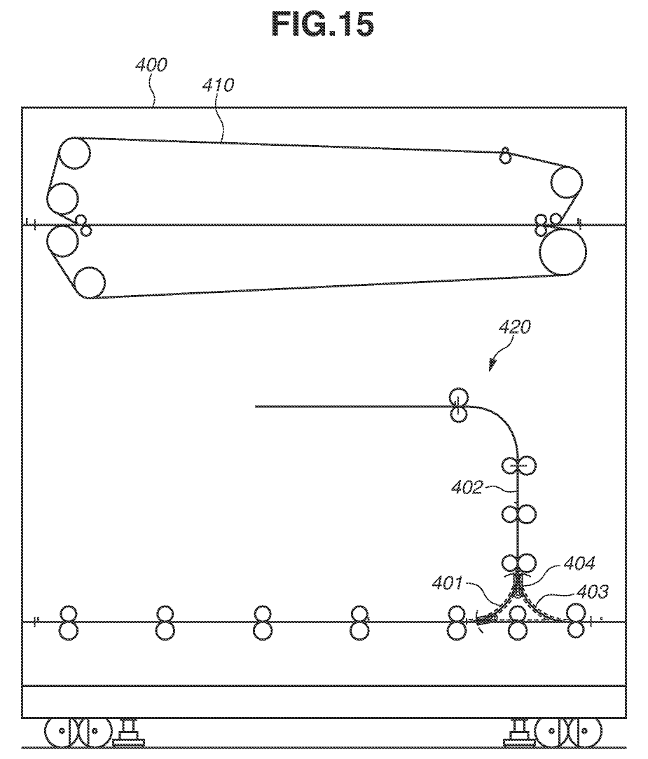

FIG. 15 is a cross-sectional view of the fixing module 400. The duplex conveyance unit 430 of the fixing module 400 includes a first reversing unit 420 that reverses front and rear surfaces of the sheet. The first reversing unit 420 of the duplex conveyance unit 430 includes a pre-reversing conveyance path 401, a reversing conveyance path 402, a post-reversing conveyance path 403, and a reversing flapper 404. The pre-reversing conveyance path 401 and the post-reversing conveyance path 403 of the first reversing unit 420 are bent. The reversing flapper 404 including a part of the pre-reversing conveyance path 401 and a part of the post-reversing conveyance path 403 is disposed at an end point of the pre-reversing conveyance path 401 and a start point of the post-reversing conveyance path 403 in a direction of sheet conveyance.

The number of sheets conveyed to the first reversing unit 420 disposed in the duplex conveyance unit 430 is less than that of the second reversing unit 641 because the sheet to be subjected to duplex printing is conveyed to the first reversing unit 420. For this reason, the sheet interval is relatively wide, and accordingly has a margin. Thus, the position of the reversing flapper 404 is switched to a position at which the reversing flapper 404 overlaps with a conveyance guide included in the pre-reversing conveyance path 401 and a position at which the reversing flapper 404 overlaps with a conveyance guide included in the post-reversing conveyance path, as viewed from the sheet width direction. However, as with the second reversing unit 641, the position of the reversing flapper 404 of the first reversing unit 420 may be switched to a first position where the reversing flapper 404 does not block the pre-reversing conveyance path 401 and the post-reversing conveyance path 403, and a second position where the reversing flapper 404 blocks the pre-reversing conveyance path 401 but does not block the post-reversing conveyance path 403.

As described above, in the present embodiment, the position of the reversing flapper 610 is switched to the second position where the reversing flapper 610 blocks the pre-reversing conveyance path 601 but does not block the post-reversing conveyance path 603, and the first position where the reversing flapper 610 does not block the pre-reversing conveyance path 601 and the post-reversing conveyance path 603. The first position of the reversing flapper 610 is a position where the reversing flapper 610 can convey the sheet from the pre-reversing conveyance path 601 to the reversing conveyance path 602, and can convey the sheet from the reversing conveyance path 602 to the post-reversing conveyance path 603. Accordingly, the position of the reversing flapper 610 can be switched from the second position to the first position without damaging the trailing edge of the sheet conveyed from the reversing conveyance path 602 to the post-reversing conveyance path 603.

In the present embodiment, at a timing when rotation of the reversing rollers secured in time are switched from the normal rotation to the reverse rotation, the posture of the reversing flapper 610 is switched from the pre-reversing guiding posture (first position) to the post-reversing guiding posture (second position). In addition, the posture of the reversing flapper 610 is switched from the post-reversing guiding posture (second posture) to the pre-reversing guiding posture (first position) while the sheet on which switchback has been already performed passes the reversing flapper 610. This enables the reversing flapper 610 to shift into a posture in which the reversing flapper 610 can receive a subsequent sheet with sufficient time to spare. As a result, an actuator and a mechanism having high output and high responsiveness become unnecessary, and increase in cost can be suppressed.

In the above-described embodiment, the case where the image forming system is applied to the inkjet recording system 1 is described, but the application is not limited to the inkjet recording system, and the image forming system may be applied to an electrophotographic image forming system.

### Second Embodiment

A second embodiment of the present disclosure is described. In the first embodiment, the motor is used as an actuator for pivoting the reversing flapper 610. In the second embodiment, a solenoid 664 is used as the actuator. In the first embodiment, to control the sheet stop position for switchback, the reversing sensor 630 disposed along the reversing conveyance path 602 is used. In the second embodiment, a pre-reversing sensor 668 disposed on the upstream side of the reversing flapper 610 in the pre-reversing conveyance path 601 is used.

As described above, in the second embodiment, the type of the actuator and arrangement of the sensor used to control the sheet stop position for switchback are different from those in the first embodiment. In the second embodiment, differences of the type of the actuator and the arrangement of the sensor are described, but any one of the type of the actuator and the arrangement of the sensor may be different from that of the first embodiment. The other components are similar to the components in the first embodiment. Accordingly, the components are denoted by the same reference numerals and detailed description of the components are incorporated by reference for conciseness.

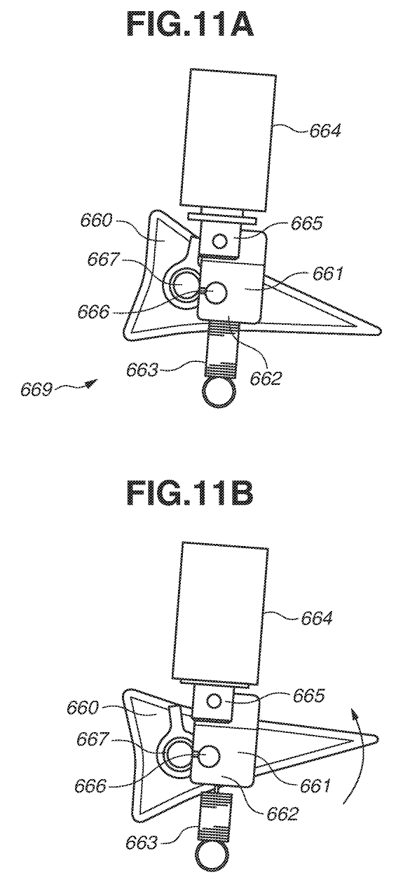

FIGS. 11A and 11B are diagrams illustrating a reversing flapper driving unit and a reversing flapper according to the second embodiment. FIG. 11A is a diagram illustrating a reversing flapper 660 positioned at the first position, and FIG. 11B is a diagram illustrating the reversing flapper 660 positioned at the second position. The reversing flapper 660 includes a reversing flapper shaft 667, and pivots around the reversing flapper shaft 667. The reversing flapper shaft 667 is pivotably supported by a side plate.

A reversing flapper driving unit 669 includes a flapper arm 661, the solenoid 664, and a spring 663. The flapper arm 661 is fixed to the reversing flapper shaft 667, and includes a spring hooking portion 662 and a plunger engaging portion 666. The spring 663 is hooked to the spring hooking portion 662 of the flapper arm 661. The solenoid 664 is fixed to a side plate. A plunger 665 of the solenoid 664 engages with the plunger engaging portion 666 of the flapper arm 661.

The flapper arm 661 is urged by the spring 663 in a direction in which the spring hooking portion 662 is separated from the solenoid 664. When a voltage is applied to the solenoid 664, the plunger 665 is drawn into a solenoid main body, and accordingly, the flapper arm 661 pivots, and the reversing flapper 660 also pivots around the flapper shaft 667 in a counterclockwise direction (arrow in FIG. 11B). In other words, when the voltage is applied to the solenoid 664, the posture of the reversing flapper 660 is switched from the pre-reversing guiding posture (first position) to the post-reversing guiding posture (second position). When application of the voltage to the solenoid 664 is stopped, the posture of the plunger 665 is switched from the post-reversing guiding posture (second position) to the pre-reversing guiding posture (first position) by the own weight and the spring 663.

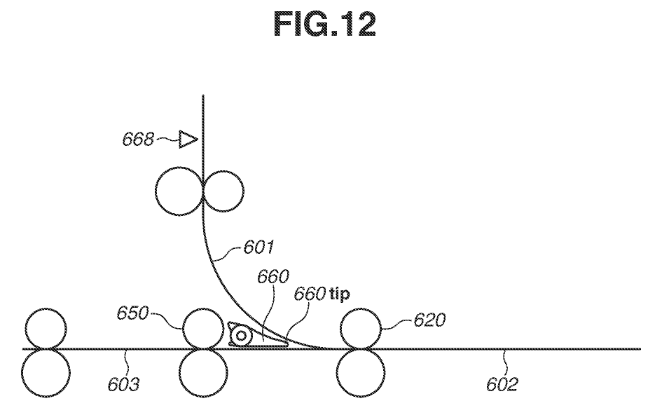

FIG. 12 is a cross-sectional view illustrating a second reversing unit according to the second embodiment. The pre-reversing sensor 668 is disposed on an upstream side of the reversing flapper 610 in the pre-reversing conveyance path 601. At a timing when the sheet on which switchback has not been performed yet is conveyed by a predetermined distance from a timing when the trailing edge of the sheet passes the pre-reversing sensor 668, rotation of the reversing rollers 620 is stopped. As a result, the sheet is stopped in the reversing conveyance path 602. At this time, immediately after the trailing edge of the sheet passes a tip of the reversing flapper 660, the solenoid 664 serving as the driving unit switches the posture of the reversing flapper 660 from the pre-reversing guiding posture (first position) to the post-reversing guiding posture (second position).

In a state where the reversing flapper 660 is at the second position, the reversing rollers 620 are reversely rotated to convey the sheet. Thereafter, in a state where the sheet is conveyed by the post-reversing conveyance rollers 650, the solenoid 664 switches the posture of the reversing flapper 660 from the post-reversing guiding posture (second position) to the pre-reversing guiding posture (first position).

Sizes of cut sheets may vary due to cutting in a manufacturing process. Further, the sizes of the cut sheets expand/contract due to increase/decrease of a moisture content of the sheets in an image forming process. In the second embodiment, the sheet is stopped at the timing when the sheet is conveyed by the predetermined distance after the pre-reversing sensor 668 detects the trailing edge of the sheet. Thus, it is possible to reduce variation of the sheet position when the leading edge and the trailing edge of the sheet are switched before and after switchback is performed, which stabilizes sheet conveyance.

In other words, the trailing edge of the sheet when the sheet is conveyed from the pre-reversing conveyance path 601 to the reversing conveyance path 602 turns into the leading edge of the sheet when the sheet is conveyed from the reversing conveyance path 602 to the post-reversing conveyance path 603.

For this reason, by switching the conveyance direction at the timing when the sheet is conveyed by the predetermined distance after the pre-reversing sensor 668 detects the trailing edge of the sheet, variation in position of the leading edge of the sheet is small during conveyance of the sheet from the reversing conveyance path 602 to the post-reversing conveyance path 603 even when variation occurs in the sizes of the sheets.

In the present embodiment, the position of the reversing flapper 660 is also switched to the first position where the reversing flapper 660 does not block the pre-reversing conveyance path 601 and the post-reversing conveyance path 603 and the second position where the reversing flapper 660 blocks the pre-reversing conveyance path 601 but does not block the post-reversing conveyance path 603. Accordingly, it is possible to realize conveyance of the sheet without damaging the trailing edge of the sheet.

According to the present disclosure, it is possible to realize high productivity.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-172774, filed October 1, 2024, which is hereby incorporated by reference herein in its entirety.

WHAT IS CLAIMED IS:

1. A sheet conveyance apparatus comprising:
a first conveyance path through which a sheet is conveyed;
reversing rollers configured to convey a sheet in at least one of a forward direction and a direction opposite to the forward direction;
a reversing conveyance path through which the sheet conveyed from the first conveyance path is conveyed, wherein the reversing rollers are provided along the reversing conveyance path;
a second conveyance path through which the sheet conveyed from the reversing conveyance path is conveyed;
a reversing switching unit configured to be switched to a first position to guide a leading edge of the sheet from the first conveyance path to the reversing conveyance path, and a second position to guide the leading edge of the sheet from the reversing conveyance path to the second conveyance path; and
a driving unit configured to switch the reversing switching unit between the first position and the second position,
wherein the driving unit switches from the first position to the second position after a trailing edge of a first sheet conveyed from the first conveyance path to the reversing conveyance path passes the reversing switching unit, and
wherein the driving unit switches from the second position to the first position after a leading edge of the first sheet conveyed from the reversing conveyance path passes a tip of the reversing switching unit and before the trailing edge of the first sheet passes the tip of the reversing switching unit.

2. The sheet conveyance apparatus according to claim 1, wherein the reversing switching unit is further configured to guide a second sheet conveyed after the first sheet from the first conveyance path to the reversing conveyance path while remaining at the first position.

3. The sheet conveyance apparatus according to claim 1, wherein the second conveyance path has a curvature smaller than a curvature of the first conveyance path.

4. The sheet conveyance apparatus according to claim 1, wherein the second conveyance path is a substantially horizontal.

5. The sheet conveyance apparatus according to claim 1, wherein the driving unit includes a motor.

6. The sheet conveyance apparatus according to claim 1, further comprising conveyance rollers disposed along the second conveyance path and configured to convey the sheet.

7. The sheet conveyance apparatus according to claim 6, wherein the driving unit
is further configured to switch the position of the reversing switching unit from the second
position to the first position after the first sheet is nipped by the conveyance rollers.

8. The sheet conveyance apparatus according to claim 1, wherein the reversing
rollers are further configured to convey the sheet in the opposite direction after the
reversing switching unit is switched from the first position to the second position.

9. The sheet conveyance apparatus according to claim 1, further comprising:
a control unit configured to control rotation of the reversing rollers; and
a sensor disposed along the reversing conveyance path and configured to detect the sheet,
wherein the control unit controls rotation of the reversing rollers based on a sheet detection result from the sensor.

10. The sheet conveyance apparatus according to claim 1, further comprising:
a control unit configured to control rotation of the reversing rollers; and
a sensor disposed along the first conveyance path and configured to detect the sheet,
wherein the control unit controls rotation of the reversing rollers based on a sheet detection result from the sensor.

11. The sheet conveyance apparatus according to claim 1, further comprising:
a first guide facing the reversing switching unit and configured to form a part of the first conveyance path together with the reversing switching unit; and
a second guide facing the reversing switching unit and configured to form a part of the second conveyance path together with the reversing switching unit,
wherein, in a case where the reversing switching unit is at the second position, the reversing switching unit overlaps with the first guide, viewed from a sheet width direction, and
wherein, in a case where the reversing switching unit is at the first position, the
reversing switching unit does not overlap with the first guide and does not overlap with
the second guide, viewed from the sheet width direction.

12. An image forming apparatus, comprising:
the sheet conveyance apparatus according to claim 1; and
an image forming unit configured to form an image on at least one sheet.
